(19) United States
(12) Patent Application Publication
(10) Pub. No.: US 2012/0317087 A1
(43) Pub. Date: Dec. 13, 2012

(54) Location-Aware Search Ranking

(75) Inventors: Dimitrios Lymberopoulos, Bellevue, WA (US); Arnd C. Konig, Kirkland, WA (US); Peixiang Zhao, Urbana, IL (US); Klaus L. Berberich, Saarbruecken (DE); Jie Liu, Medina, WA (US)

(73) Assignee: MICROSOFT CORPORATION, Redmond, WA (US)

(21) Appl. No.: 13/154,456

(22) Filed: Jun. 7, 2011

(51) Int. Cl. G06F 17/30

(52) U.S. Cl. 707/706; 707/E17.084

(57) ABSTRACT

A training system is described for generating at least one ranking module using features derived, in part, from region information. The region information encodes characteristics about regions which are associated with queries in search log data. A query processing system is also described for applying the ranking model generated by the training system to process queries in real time. In one implementation, the training system can also generate plural ranking models corresponding to plural respective map areas. The training system can also generate a mapping model which correlates each region with a ranking model to be applied when processing queries that originate from that region. The query processing system can process a query by determining a region associated with the query and then identifying and applying a ranking model which corresponds to the region.

### BACKGROUND

A search engine can use various techniques to generate search results based, in part, on the location of a user who has submitted a query. These techniques are effective in some scenarios. But there is considerable room for improvement in location-based ranking techniques.

### SUMMARY

A training system is described for generating one or more ranking models from search log data. The training system generates the ranking models based on features which derive, in part, from region information. The region information, in turn, encodes characteristics about regions (e.g., zip code regions, map tile regions, etc.) which are associated with queries in the search log data.

Without limitation, for example, the features can include one or more of the following illustrative location-related features. A first feature encodes a population density of a region from which a query originated. A second feature encodes an average traveling distance for the region. The average traveling distance corresponds to an average distance that users are willing to travel to reach target entities (such as businesses, events, etc.). A third feature encodes a standard deviation of the traveling distances for the region. A fourth feature encodes a self-sufficiency value for the region. The self-sufficiency value indicates an extent to which users within the region have selected target entities outside the region in response to queries issued by the users. A fifth feature encodes a fractional value for the region. The fractional value indicates a fraction of query volume that the region receives, with respect to a total volume associated with a more encompassing region. Other implementations may introduce additional location-related features and/or omit one or more of the location-related features described above.

According to another illustrative aspect, the training system generates plural ranking models that correspond to plural respective map areas (e.g., counties, states, provinces, etc.). The training system can generate the ranking models by partitioning a general undifferentiated collection of search log data into a plurality of datasets, each dataset corresponding to a respective map area. The training system then generates a collection of features for each dataset. The training system then generates plural respective ranking models from the respective collections of features. For instance, instead of training a single ranking model for an entire country, the training system can generate different ranking models for individual regions in the country (e.g., states and/or cities), as well as, optionally, a ranking model for the entire country.

According to another illustrative aspect, the training system generates a mapping model which correlates a particular region (e.g., a particular zip code, etc.) with a ranking model for processing queries which originate from that region. The training system can generate the mapping model by testing a performance of each ranking model for a dataset associated with each region. This provides a plurality of performance results for the respective regions. The training system can then determine the mapping model based on the plurality of performance results, e.g., by picking the ranking model that provides the best results for each region. For instance, for a specific set of regions (e.g., zip codes) in New York State, the state model might achieve the best performance. Conversely, for the Manhattan region of New York City, a New York City model might achieve better performance. Generally, the mapping model will therefore map certain region identifiers to the New York state model and certain other region identifiers to the New York City model, etc.

A query processing system is also described herein for applying the ranking model (or ranking models) generated by the training system. When a user submits a query, the query processing system generates plural sets of features based on, at least in part, the region information summarized above. The query processing system then applies a ranking model to the sets of features, to provide search results. The ranking model is produced by the training system in the manner specified above.

According to another illustrative aspect, the query processing system maps a received query to a region identifier, corresponding to the region from which the query originated. The query processing system then selects a ranking model to be applied to the query based on the region identifier. The query processing system performs this mapping function using the mapping model described above.

The above approach can be manifested in various types of systems, components, methods, computer readable media, data structures, articles of manufacture, and so on.

This Summary is provided to introduce a selection of concepts in a simplified form; these concepts are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 shows an illustrative training environment for generating at least one ranking model based, in part, on region information.

FIG. 2 shows illustrative functionality for generating region information for use by the training environment of FIG. 1.

FIG. 3 shows another illustrative training environment for generating plural ranking models based, in part, on region information.

FIG. 4 shows a mapping module for generating a mapping model for use in conjunction with the training environment of FIG. 3.

FIG. 5 is an illustrative map for use in explaining one application of the training systems of FIGS. 1 and 3.

FIG. 6 shows an illustrative query processing environment for applying the ranking module(s) generated by the training environments of FIGS. 1 and 3.

FIG. 7 shows an illustrative meta-model that can be applied by the query processing environment of FIG. 6.

FIG. 8 shows a procedure that sets forth one illustrative manner of operation of the training systems of FIGS. 1 and 3.

FIG. 9 shows a procedure that sets forth one illustrative manner of operation of the functionality of FIG. 2 (for generating region information).

FIG. 10 shows a procedure that sets forth one illustrative manner of generating plural ranking models, in the context of the procedure of FIG. 8.

FIG. 11 shows a procedure that sets forth one illustrative manner of generating a mapping model, in the context of the procedure of FIG. 8.

FIG. 12 shows a procedure that sets forth one illustrative manner of operation of the query processing environment of FIG. 6.

FIG. 13 shows a procedure that sets forth one manner of selecting and applying a particular ranking model, within the context of the procedure of FIG. 12.

FIG. 14 shows illustrative computing functionality that can be used to implement any aspect of the features shown in the foregoing drawings.

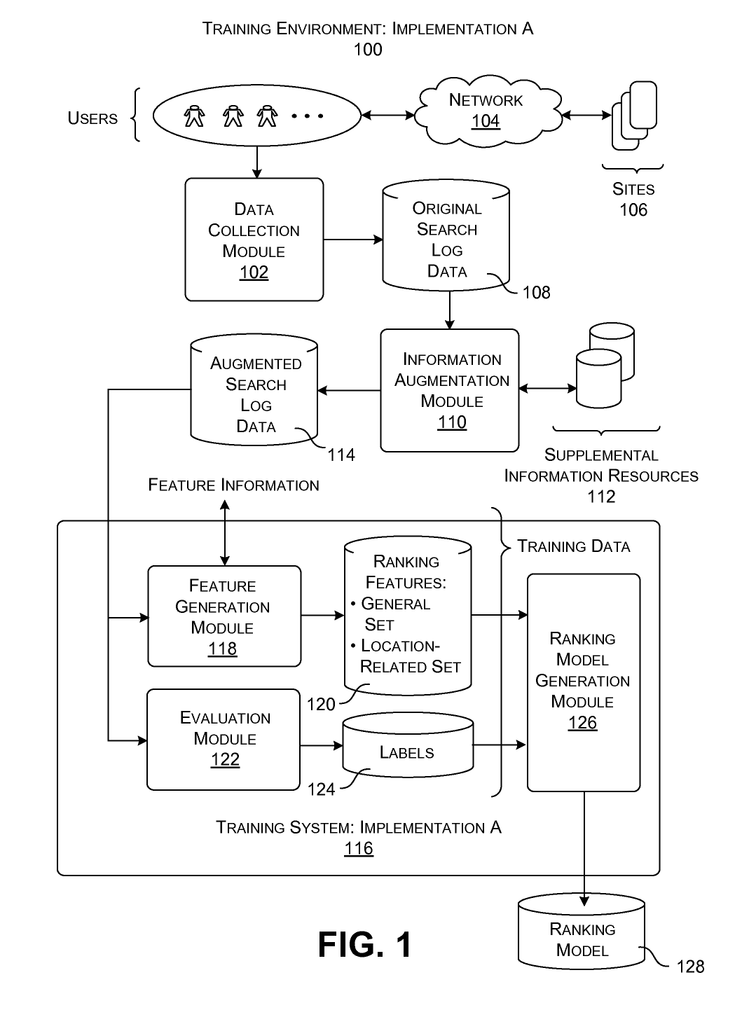

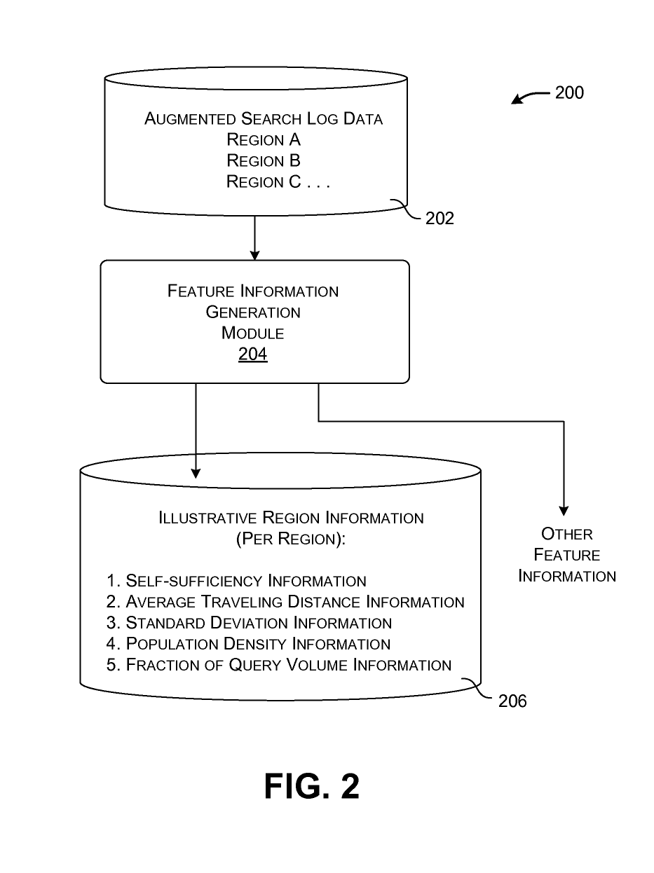

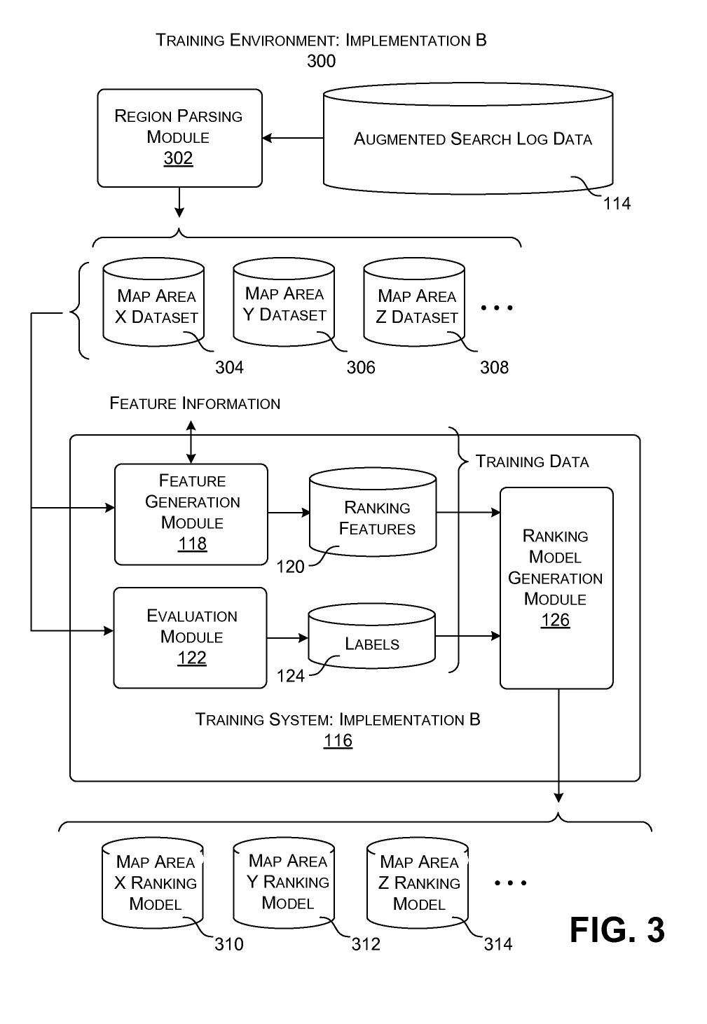

The same numbers are used throughout the disclosure and figures to reference like components and features. Series 100 numbers refer to features originally found in FIG. 1, series 200 numbers refer to features originally found in FIG. 2, series 300 numbers refer to features originally found in FIG. 3, and so on.

### DETAILED DESCRIPTION

This disclosure is organized as follows. Section A describes illustrative functionality for generating one or more ranking models based, in part, on region information, and then for applying the ranking model(s) to process queries in real time. Section B describes illustrative methods which explain the operation of the functionality of Section A. And Section C describes representative computing functionality that can be used to implement any aspect of the features described in Sections A and B.

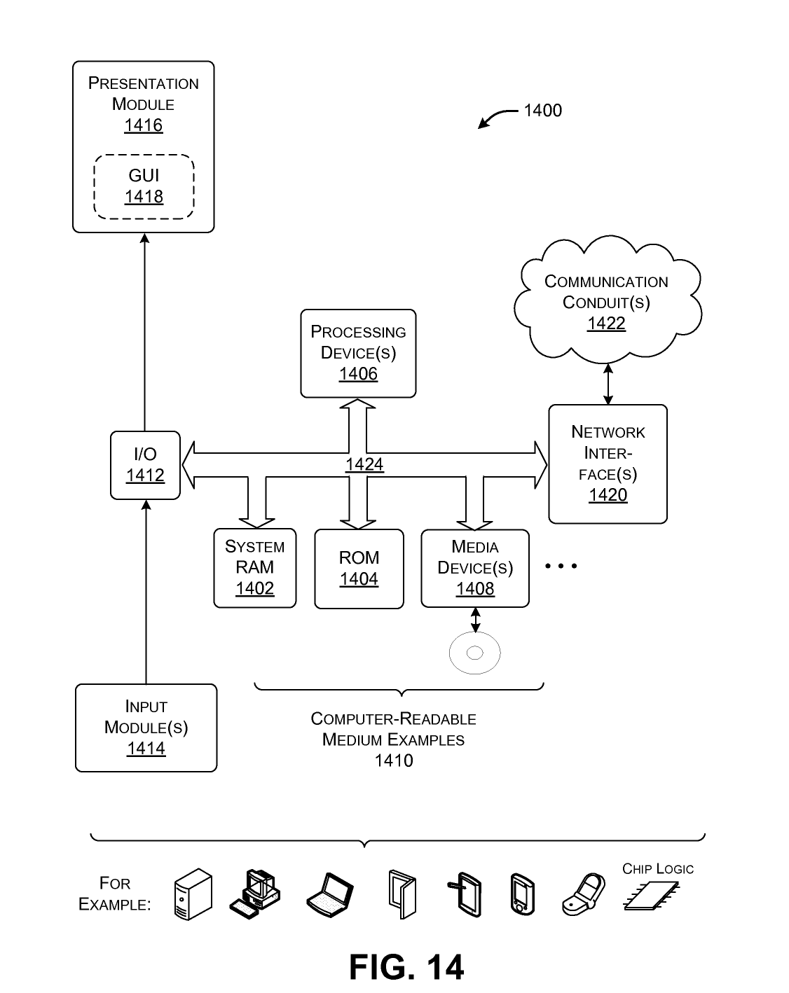

As a preliminary matter, some of the figures describe concepts in the context of one or more structural components, variously referred to as functionality, modules, features, elements, etc. The various components shown in the figures can be implemented in any manner by any physical and tangible mechanisms, for instance, by software, hardware (e.g., chip-implemented logic functionality), firmware, etc., and/or any combination thereof. In one case, the illustrated separation of various components in the figures into distinct units may reflect the use of corresponding distinct physical and tangible components in an actual implementation. Alternatively, or in addition, any single component illustrated in the figures may be implemented by plural actual physical components. Alternatively, or in addition, the depiction of any two or more separate components in the figures may reflect different functions performed by a single actual physical component. FIG. 14, to be discussed in turn, provides additional details regarding one illustrative physical implementation of the functions shown in the figures.

Other figures describe the concepts in flowchart form. In this form, certain operations are described as constituting distinct blocks performed in a certain order. Such implementations are illustrative and non-limiting. Certain blocks described herein can be grouped together and performed in a single operation, certain blocks can be broken apart into plural component blocks, and certain blocks can be performed in an order that differs from that which is illustrated herein (including a parallel manner of performing the blocks). The blocks shown in the flowcharts can be implemented in any manner by any physical and tangible mechanisms, for instance, by software, hardware (e.g., chip-implemented logic functionality), firmware, etc., and/or any combination thereof.

As to terminology, the phrase “configured to” encompasses any way that any kind of physical and tangible functionality can be constructed to perform an identified operation. The functionality can be configured to perform an operation using, for instance, software, hardware (e.g., chip-implemented logic functionality), firmware, etc., and/or any combination thereof.

The term “logic” encompasses any physical and tangible functionality for performing a task. For instance, each operation illustrated in the flowcharts corresponds to a logic component for performing that operation. An operation can be performed using, for instance, software, hardware (e.g., chip-implemented logic functionality), firmware, etc., and/or any combination thereof. When implemented by a computing system, a logic component represents an electrical component that is a physical part of the computing system, however implemented.

The following explanation may identify one or more features as “optional.” This type of statement is not to be interpreted as an exhaustive indication of features that may be considered optional; that is, other features can be considered as optional, although not expressly identified in the text. Finally, the terms “exemplary” or “illustrative” refer to one implementation among potentially many implementations.

A. Illustrative Functionality for Generating and Applying Ranking Models

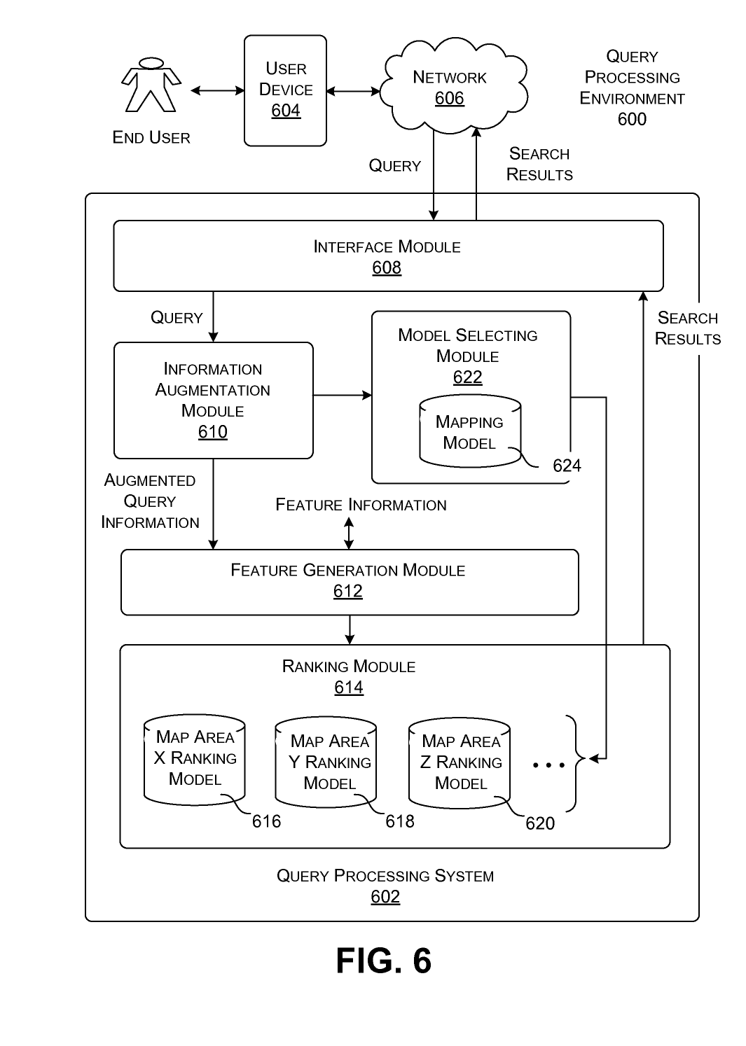

FIG. 1 shows an illustrative training environment 100 for generating one or more ranking models for use in a query processing system (to be described with respect to FIG. 6). In one implementation, the training environment 100 generates the ranking model(s) in an offline stage of processing, while the query processing system operates in real time by dynamically providing search results in response to the submission of queries. But any aspect of the training environment 100 can also be performed in a dynamic manner. For example, the training environment 100 can periodically or continuously update its models based on the collection of additional search log data.

The training environment 100 includes a data collection module 102 for collecting search log data that describes searches conducted by users. In one case, the users perform these searches using mobile user devices (not shown), e.g., using mobile telephones, laptop computers, personal digital assistants (PDAs), electronic book reader devices, vehicle-borne computers, and so on. In addition, or alternatively, the users perform these searches using generally stationary computing equipment, such as personal computers, game console devices, set-top box devices, and so on.

In an individual search, a user submits a query to a search engine (not shown) over a network 104 (such as the Internet), in optional conjunction with one or more wireless communication systems. In response to the query, the search engine provides search results to the user. The search results typically identify a list of one or more result items that have been assessed as being relevant to the user's query. For example, the list may identify a list of network-accessible sites 106 and/or database entries that satisfy the user's query. Some of the network-accessible sites 106 may pertain to target entities that are associated with respective locations. For example, the target entities may correspond to businesses, events, etc. that have physical locations associated therewith.

The data collection module 102 can collect the search log data in various ways. In one way, the user devices (operated by the users) may use a push technique to independently forward the search log data to the data collection module 102. Alternatively, or in addition, the data collection module 102 may use a pull technique to obtain the search log data from any source(s), such as the user devices, a search engine data store, etc. The data collection module 102 can store the search log data in a data store 108.

Each instance of the search log data can include multiple components. A first component may contain the text of a query string. A second component may describe a location associated with the query. The location can be determined in various ways, such as by using an IP address lookup technique, a cell tower or WIFI triangulation technique, a GPS technique, and so on (or any combination thereof). In addition, or alternatively, a user can manually specify his or her location. Or the data collection module 102 can determine the location based on a user's profile information and/or preference information, etc. A third component may describe the time and date that the user has submitted the query. A fourth component may describe information regarding the result items that were presented to the user in response to the query, e.g., identified by website addresses, business IDs, or any other identifiers. A fifth component may describe the result item(s) that the user acted on (if any) within the search results (such as by clicking on a result item, contacting or researching a business associated with the result item, and so on). These components are cited by way of example, not limitation; other implementations can collect other components of information that characterize the users' searches.

An information augmentation module 110 adds supplemental information to the search log data to provide augmented search log data. For example, the information augmentation module 110 can map each location associated with each query to a region identifier. The region identifier identifies a general region from which the query originated. To facilitate explanation, the following description will predominately use an example in which the regions correspond to different zip code areas. However, the regions can be defined with respect to any level of geographic granularity, such as a state or province level, a county level, a city or town level, a congressional district level, a school district level, a map tile level, and so on. The information augmentation module 110 can obtain the region identifiers from one or more supplemental information resources 112, such as one or more lookup tables (e.g., which map latitude/longitude positions to zip codes). In addition, the information augmentation module 110 can extract additional information from the supplemental resources pertaining to the identified regions, such as the populations of the identified regions, etc. The information augmentation module 110 can also extract information regarding any entity identified in the search results for a particular query. The information augmentation module 110 stores the augmented search log data in a data store 114.

A training system 116 operates on the augmented search log data to produce one or more ranking models. As part of this process, a feature generation module 118 generates a set of features which describe each pairing of a query and a result item identified in the augmented search log data. To be more concrete, an illustrative query may specify the keywords “Ocean view seafood restaurant,” and one of the result items may pertain to a hypothetical restaurant, “The Harbor Inn,” located within the waterfront district of a particular city. Some of the features may pertain to the query itself (“Ocean view seafood restaurant”), without reference to the result item. Other features may pertain to the result item itself (e.g., the business identified by the result item, “The Harbor Inn”) And other features may pertain to a combination of the query and the result item (e.g., the distance between the query location and the result item's location).

More specifically, the feature generation module 118 can generate two classes of features. A first class pertains to any set of general-purpose features that any search engine may already use to rank result items. For example, in one representative environment, the first class of features may include: a) a feature that identifies the time of day at which the query was submitted; b) a binary feature that indicates whether the query was submitted on a workday or over the weekend; c) a feature that identifies the popularity of the business (e.g., as identified by the number of times that this business has been clicked on in the search logs); d) a feature that identifies the position of the business in the search results; e) a feature that identifies the distance between the query and the business, and so on. To repeat, these general-purpose features are illustrative; other implementations can introduce additional general-purpose features and/or omit one or more of the general-purpose features described above.

A second class of features pertains to features which describe characteristics of the region from which the query originated, as identified by the region identifier. These features are referred to as location-related features. For example, a first location-related feature encodes a population density of a region from which the query originated. A second location feature encodes an average traveling distance for the region. The average traveling distance corresponds to an average distance that users are willing to travel to reach target entities (e.g., businesses, events, etc.). Each traveling distance can be represented as a distance between a current location of a user (who issues a query) and a location of a target entity (e.g., a business, etc.) that is clicked on (or otherwise acted on) in the search results. A third location-related feature encodes a standard deviation of the traveling distances for the region. A fourth location-related feature encodes a self-sufficiency value for the region. The self-sufficiency value indicates an extent to which users within the region have selected target entities outside the region in response to queries issued by the users. A fifth location-related feature encodes a fractional value for the region. The fractional value indicates a fraction of query volume of that the region receives, with respect to a total volume associated with a more encompassing region. For example, the fractional value identifies the number of queries that have been made within a particular zip code area relative to a total amount of queries that have been made within that the state in which the zip code is located. These five location-related features are cited by way of illustration, not limitation; other implementations can provide additional location-related features and/or can omit one or more of the location-related features described above.

In general, FIG. 1 indicates that the feature generation module 118 generates the features by pulling appropriate data from a corpus of feature information. FIG. 2 (described below) shows one way of generating some of the feature information. Finally, the feature generation module 118 can store the features that it produces in a data store 120. As noted above, the features can include both general-purpose features and location-related features.

An evaluation module 122 applies a judgment label to each pairing of a query and a result item. The judgment label indicates whether the result item has satisfied the user's query. The evaluation module 122 can use different techniques to provide these labels. In one case, the evaluation module 122 provides an interface that enables a human analyst to manually provide the labels. Alternatively, or in addition, the evaluation module 122 can use an automated technique to apply the labels. For example, the evaluation module 122 can assign a first value to a result item if the user acted on it in the search results and a second value if the user did not act on it. This presumes that the user was satisfied with the result item if he or she clicked on it or otherwise acted on it. This assumption can be qualified in various ways. For example, the evaluation module 122 can identify a result item as satisfying a user's query only if it was clicked on at the end of a user's search session, and/or if the user did not click on any other result item within a predetermined amount of time (e.g., 30 seconds) after clicking on the result item. The evaluation module 122 stores the labels in a data store 124. Collectively, the ranking features (in the data store 120) and the labels (in the data store 124) constitute training data which is used to train the ranking model.

A ranking model generation module 126 operates on the training data to produce at least one ranking model. From a high-level standpoint, the ranking model generation module 126 employs machine learning techniques to learn the manner in which the features are correlated with the judgments expressed by the labels, e.g., using a click prediction paradigm. The ranking model generation module 126 can use any algorithm to perform this operation, such as, without limitation, the LambaMART technique described in Wu, et al., “Ranking, Boosting, and Model Adaptation,” Technical Report MSR-TR-2008-109, Microsoft® Corporation, Redmond, Wash., 2008, pp. 1-23. The LambaMART technique uses a boosted decision tree technique to perform ranking, producing a ranking model that comprises weights applied to the features. More generally, machine learning systems can draw from any of: support vector machine techniques, genetic programming techniques, Bayesian network techniques, neural network techniques, and so on. The ranking model generation module 126 stores the ranking model(s) in a data store 128.

The components shown in the training environment 100 can be implemented by any computing functionality, such as one or more computer servers, one or more data stores, routing functionality, etc. The functionality provided by the training environment 100 can be provided at a single site (such as a single cloud computing site) or can be distributed over plural sites.

Advancing to FIG. 2, this figure shows functionality 200 for generating feature information that can be used by the training system 116 (of FIG. 1) to generate the general-purpose features and the location-related features. The functionality 200 includes a data store 202 for storing the type of augmented search log data described above. In particular, the augmented search data may describe searches conducted by users over a span of time. In addition, the augmented search log data may correlate each query with a region from which it originated.

A feature information generation module 204 generates feature information from the augmented search log data. For example, the feature information generation module 204 can partition the augmented search log data into datasets corresponding to regions. It can then generate region information which characterizes the regions based on the respective datasets. The training system 116 can use the region information to construct location-related features. The feature information generation module 204 can also generate other information. The training system 116 can use the other information to generate general-purpose features.

To cite one example, for each region, the feature information generation module 204 can identify the distances between queries (issued in that region) and businesses that were clicked on (or otherwise acted on) in response to the queries. The feature information generation module 204 can then form an average of these distances to provide average traveling distance information for this region. More generally, the region information can include any of: self-sufficiency information, average traveling distance information, standard deviation information, popularity density information, and fraction of query volume information. These pieces of information correlate with the types of location-related features described above. A data store 206 can store the region information.

In general, the location-related features provide information that enables the training system 116 to train a ranking model that properly models the different ways people act on search result items in different locations. For instance, the average traveling distance per zip code provides information that enables the training system 116 to produce a ranking model that captures how far a user is willing to travel to visit a business based on his or her zip code. In other words, based on this feature, the training system 116 can implicitly learn to rank nearby businesses differently, depending on the zip code from which the query originated. As noted above, in one implementation, the ranking model can be expressed as weights applied to respective features, where the weights are learned in the course of the training process.

FIG. 3 shows one implementation of another training environment 300. By way of overview, the training environment 100 of FIG. 1 generates a ranking model that implicitly takes into account different regions having different respective characteristics. This is because the ranking model is built from features which capture region information from different regions. In contrast, the training environment 300 of FIG. 3 explicitly forms different ranking models for different respective map areas. To provide a concrete example, a first map area may correspond to an entire country. A second series of map areas may correspond to states or provinces within the country. A third series of map areas may correspond to cities within the country, and so on. Other implementations can define any other gradation of geographic areas.

To begin with, a region parsing module 302 parses augmented search log data provided in a data store 114 to produce a plurality of datasets corresponding to different respective map areas. A plurality of data stores (e.g., data stores 304, 306, 308, etc.) store the datasets, where the different data stores may correspond to different sections in a single storage device or different respective storage devices. For example, a map area X dataset in a data store 304 may contain an entire corpus of search log data for an entire country. A map area Y dataset in a data store 306 may contain a part of the search log data having queries which originate from a particular state, and so on.

A training system 116 generates a separate ranking module for each dataset using the same functionality described above, e.g., including a feature generation module 118, an evaluation module 122, data stores (120, 124), and a ranking model generation module 126. This yields a plurality of ranking models that may be stored in respective data stores (310, 312, 314, etc.), where the different data stores may correspond to different sections in a single storage device or different respective storage devices. For example, the training system 116 generates a country ranking model based on the country-level dataset for storage in a data store 310. The training system 116 generates a state ranking model based on a state-level dataset for storage in the data store 312, and so on.

In addition to generating plural ranking models, the training environment 300 may also generate a mapping model. A mapping model maps region identifiers to ranking models. In a query-time stage of processing, a query processing system can consult the mapping model to determine which of the plural ranking models is appropriate to apply when processing a query from a particular region (e.g., a particular zip code area). The query-time processing will be explained below in greater detail.

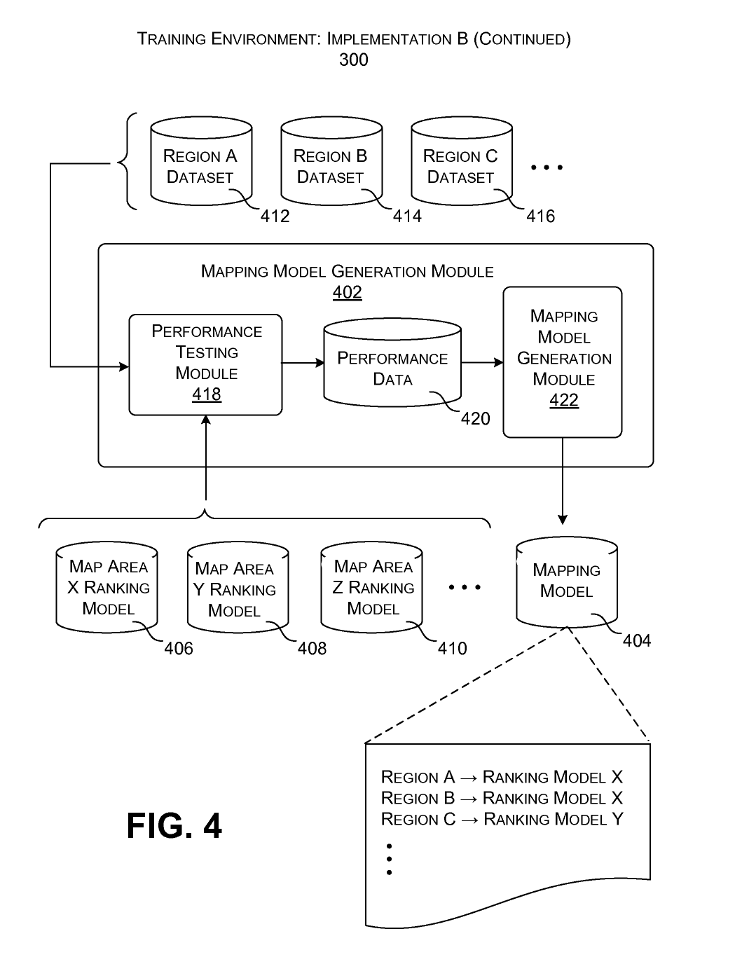

FIG. 4 shows illustrative details of a mapping model generation module 402 for generating a mapping model, for storage in a data store 404. By way of overview, the mapping model generation module 402 operates by testing the accuracy of different available ranking models for different respective regions. As described above, the ranking models may correspond to different respective map areas. Data stores (406, 408, 410, etc.) store the different ranking models, where the different data stores may correspond to different sections in a single storage device or different respective storage devices. The regions may correspond to different zip code areas, map tile areas, etc. Data stores (412, 414, 416, etc.) store datasets associated with the respective regions, etc., where the different data stores may correspond to different sections in a single storage device or different respective storage devices

More specifically, a performance testing module 418 can apply a particular ranking model to a particular regional dataset to generate ranking results. The performance testing module 418 can then compare the ranking results against some reference that defines what is considered preferred ranking results, such as selections made by a group of human users. This yields performance data for the particular paring of region and ranking model. The performance testing module 418 can repeat this operation for each pairing of region and ranking model. A data store 420 stores plural instances of the performance data generated by the performance testing module 418.

A mapping model generation module 422 generates the mapping model on the basis of the performance data. The mapping model generation module 422 performs this task by selecting the ranking model which yields the most accurate results for each region under consideration. The mapping model generation module 422 can express these correlations as a lookup table which maps region identifiers and ranking models.

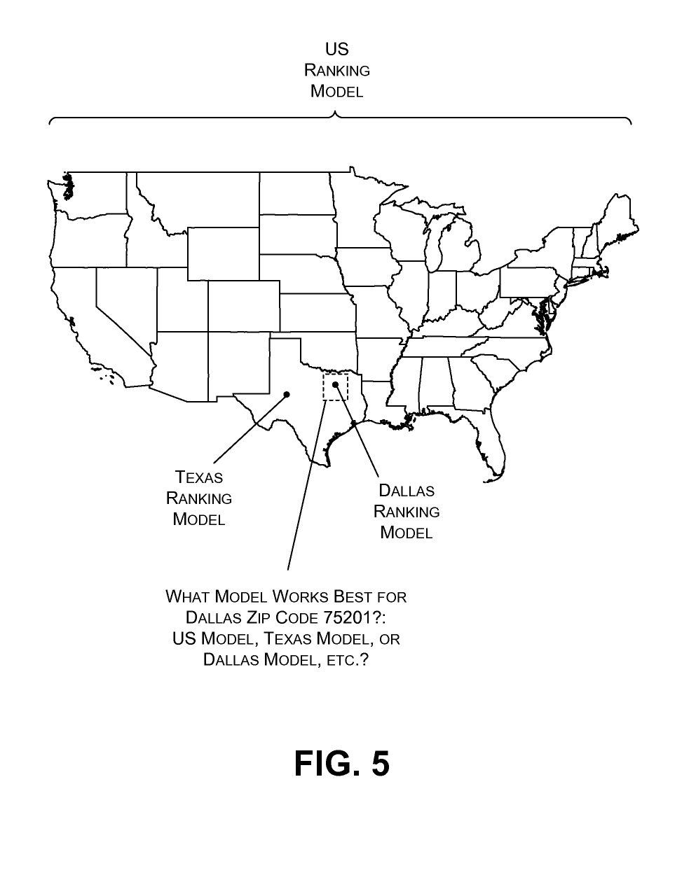

FIG. 5 shows an example of the application of the training environment 300 described in FIGS. 3 and 4. In this case, the training environment 300 can generate a first ranking model based on queries submitted from all states of the United States. The training environment 300 can also generate ranking models based on queries submitted in respective individual states. The training environment can also generate ranking models for selected cities having large populations, and so on.

Consider the specific case of zip code 75201, which encompasses part of the city of Dallas, Tex. To determine what ranking model works best for this region, the mapping model generation module 402 can process queries from this region with respect to ranking models for the entirety of the United States, the entirety of Texas, and the city of Dallas itself. In some cases, the city-level ranking model may provide the most accurate results. But in other cases, a ranking model for a more encompassing region may be more effective. Generally, the mapping model generation module 402 generates a mapping model, which captures these types of comparative judgments on a region-by-region basis.

Assume that the performance data indicates that the state of Texas ranking model (which was created with state of Texas training data) produces the best results for the zip code 75201. The mapping model generation module 422 will therefore map the zip code 75201 to the state of Texas ranking model. The query processing system (to be described below) will therefore apply the state of Texas ranking model to every query that originates from the zip code 75201.

Advancing to FIG. 6, this figure shows a query processing environment 600 having a query processing system 602. The query processing system 602 generates search results for a query submitted by a user in a query-time phase of operation. The query processing system 602 performs this operation using the implicit ranking model(s) generated by training environment 100 of FIG. 1 or the explicit per-map-area (regional) ranking models generated by the training environment 300 of FIG. 3.

The query processing system 602 can be implemented by any computing functionality, such as one or more computer servers, one or more data stores, routing functionality, etc. The functionality provided by the query processing system 602 can be provided at a single site (such as a single cloud computing site) or can be distributed over plural sites. The query processing system 602 may be informally referred to as a search engine.

An end user may interact with the query processing system 602 using any user device 604. For example, the user device 604 may comprise a personal computer, a computer workstation, a game console device, a set-top device, a mobile telephone, a personal digital assistant device, a book reader device, and so on. The user device 604 connects to the query processing system 602 via a network 606 of any type. For example, the network 606 may comprise a local area network, a wide area network (e.g., the Internet), a point-to-point connection, etc., as governed by any protocol or combination of protocols.

The query processing system 602 may employ an interface module 608 to interact with the end user. More specifically, the interface module 608 receives search queries from the end user and sends search results to the end user. The search results generated in response to a particular query represent the outcome of processing performed by the query processing system 602. The search results may comprise a list of result items that have been ranked for the end user.

An information augmentation module 610 maps a location of the user's device to a region identifier, e.g., without limitation, a zip code (where the location of the user can be assessed in one or more ways described above). A feature generation module 612 then generates a set of features for each combination of the query and a particular candidate result item. In one case, the feature generation module 612 can perform this task by generating the same types of general-purpose features and the same types of location-related features described above.

A ranking module 614 processes the sets of features using a ranking model to generate search results (where that ranking model has been trained by one of the training environments (100, 300) described above). More specifically, in a first implementation, the ranking module 614 applies one encompassing ranking model for all regions, such as the ranking model corresponding to the United States as a whole. In another case, the ranking module 614 applies one of plural possible ranking models stored in data stores (616, 618, 620, etc.), where the different data stores may correspond to different sections in a single storage device or different respective storage devices. More specifically, a model selecting module 622 maps the region identifier associated with the query's region to an appropriate ranking model identifier, based on a mapping model stored in a data store 624. The ranking module 614 then chooses a ranking model that corresponds to the identified ranking model identifier.

In an alternative implementation, the ranking module 614 can forgo the use of a trained mapping model. Instead, the ranking module 614 can identify the smallest area associated with a query for which a ranking model exists. The ranking module 614 can then apply that selected ranking model to process the query.

In the above examples, the ranking module 614 applies a ranking model which correlates to a single discrete area of a map. Alternatively, or in addition, the ranking module 614 can apply a meta-model ranking model that encompasses plural component ranking models. Each component ranking model correlates to a different part of the map. Similarly, the training environments (100, 300) of FIGS. 1 and 3 can generate such a meta-model ranking model for use in the ranking module 614.

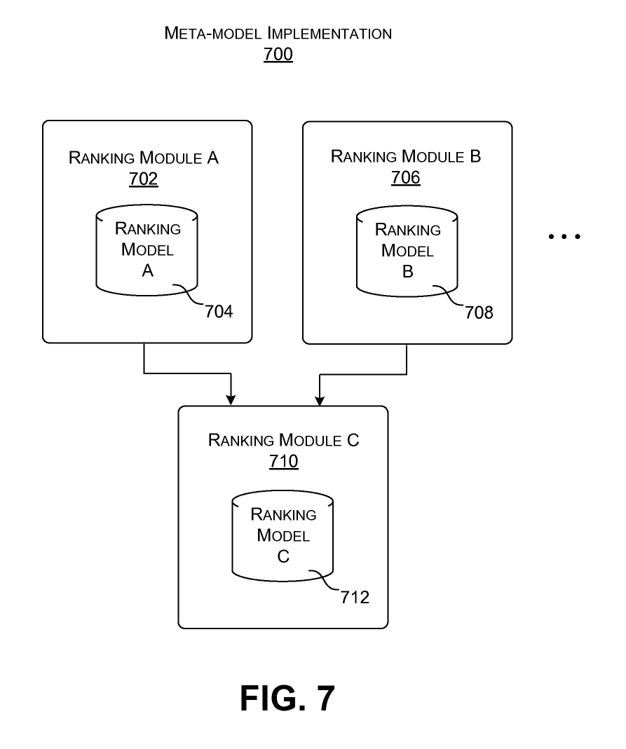

For example, FIG. 7 shows a meta-model ranking model 700 that encompasses plural component ranking models. That is, a ranking module A applies a ranking model A stored in a data store 704, a ranking module B 706 applies a ranking model B stored in a data store 708, and a ranking module C 710 applies a ranking model C stored in data store 712. For example, the ranking model A may pertain to a particular state within a country, the ranking model B may pertain to another state within the country, and the ranking model C may correspond to the country as a whole. More specifically, the ranking model C 710 adopts a set of features which includes information extracted from the outputs of the ranking model A 702 and the ranking model B 706.

B. Illustrative Processes

FIGS. 7-12 show procedures that explain one manner of operation of the functionality of Section A. Since the principles underlying the operation of this functionality have already been described in Section A, certain operations will be addressed in summary fashion in this section.

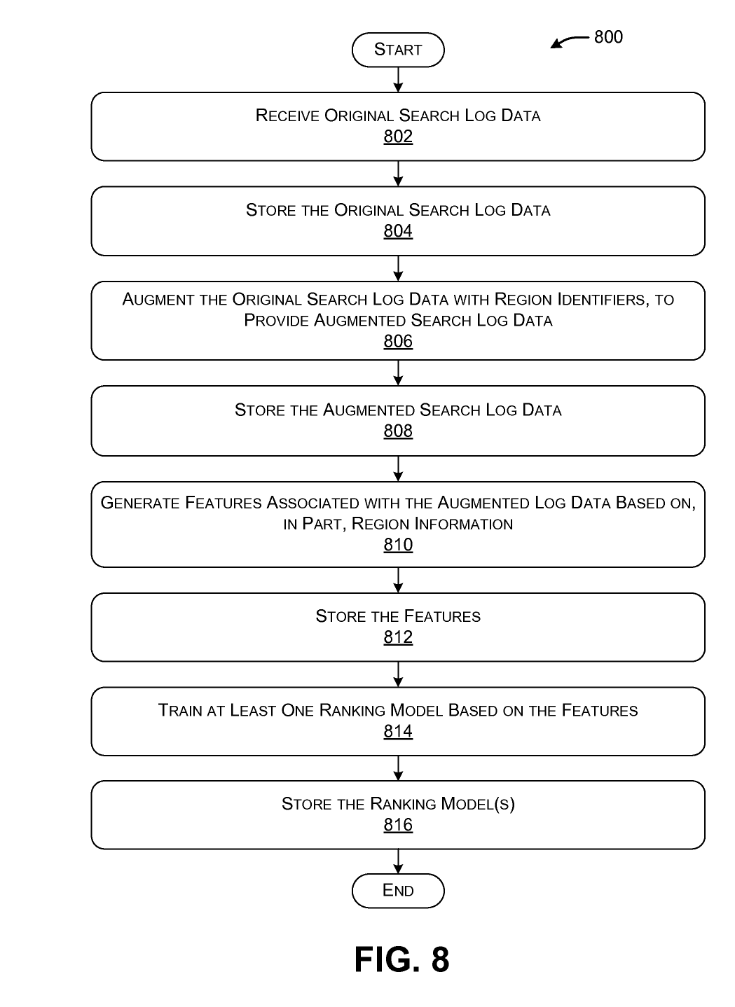

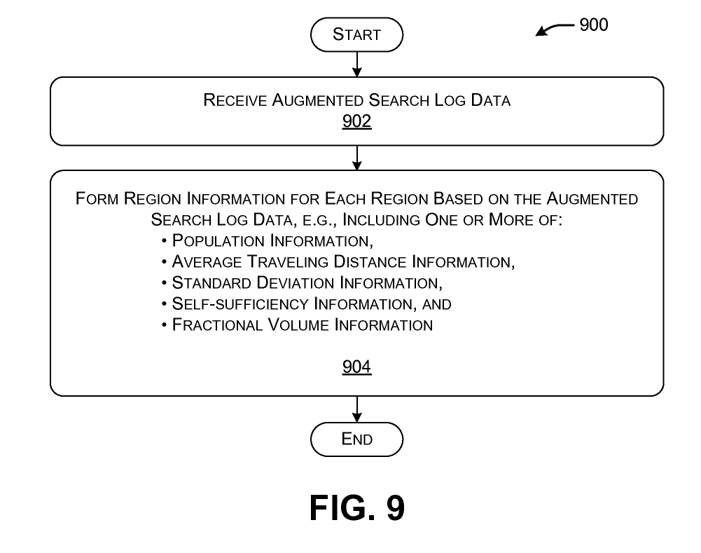

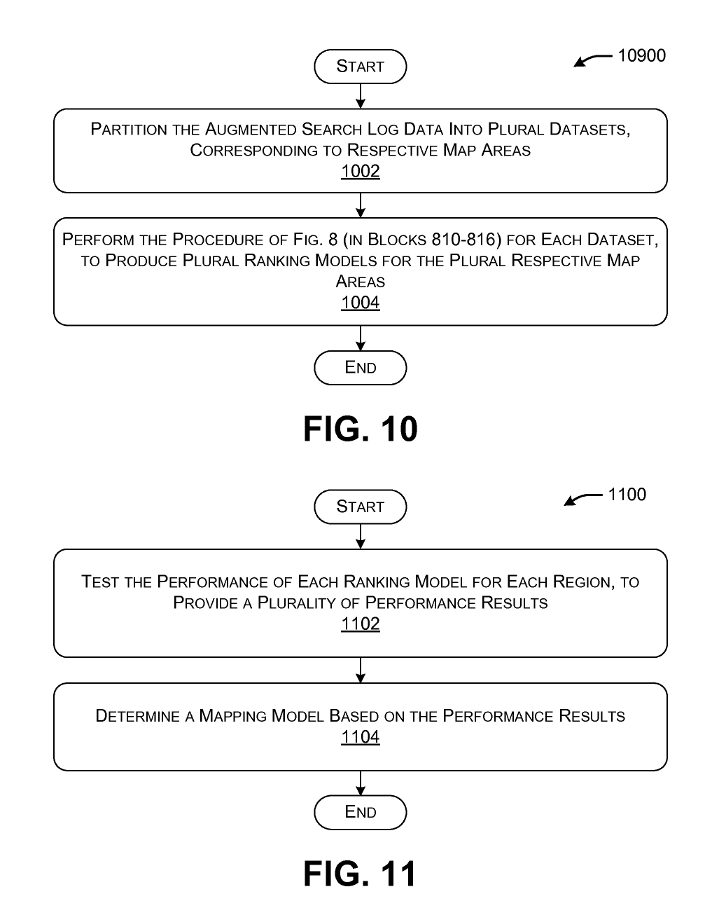

Starting with FIG. 8, this figure shows a procedure 800 that sets forth one illustrative manner of operation of the training environments (100, 300) of FIGS. 1 and 3, but will be explained with respect to the training environment 100. In block 802, the training environment 100 receives original search log data. In block 804, the training environment 100 stores the original search log data. In block 806, the training environment 100 augments the original search log data with region identifiers, to provide augmented search log data. In block 808, the training environment 100 stores the augmented search log data.

In block 810, the training environment 100 generates features associated with the augmented log data. It performs this task based on, at least in part, region information which characterizes the regions from which queries originated in the search log data. In block 812, the training environment 100 stores the features. In block 814, the training environment 100 trains at least one ranking model based on the features in conjunction with judgment labels. In block 816, the training environment 100 stores the ranking model(s).

FIG. 9 shows a procedure 900 that sets forth one illustrative manner of operation of the functionality 200 of FIG. 2 (for generating feature information, including region information). In block 902, the functionality 200 receives augmented search log data. In block 904, the functionality 200 generates different types of region information, including, for example, population information, average traveling distance information, standard deviation information, self-sufficiency information, and fractional volume information, etc. The training environment 100 of FIG. 1 uses this information to generate the location-related features.

FIG. 10 shows a procedure 1000 that sets forth one illustrative manner of generating plural ranking models, in the context of the procedure of FIG. 8. This procedure will be explained with reference to the training environment 300 of FIG. 3. In block 1002, the training environment 300 partitions the augmented search log data into plural datasets corresponds to respective map areas. In block 1004, the training environment 300 performs the procedure of FIG. 8 for each dataset. This yield plural ranking models.

FIG. 11 shows a procedure 1100 that sets forth one illustrative manner of generating a mapping model, in the context of the procedure of FIG. 8. In block 1102, the training environment 300 tests the performance of each ranking model for each region, to generate a plurality of performance results. In block 1104, the training environment 300 determines a mapping model based on the performance results obtained in block 1102.

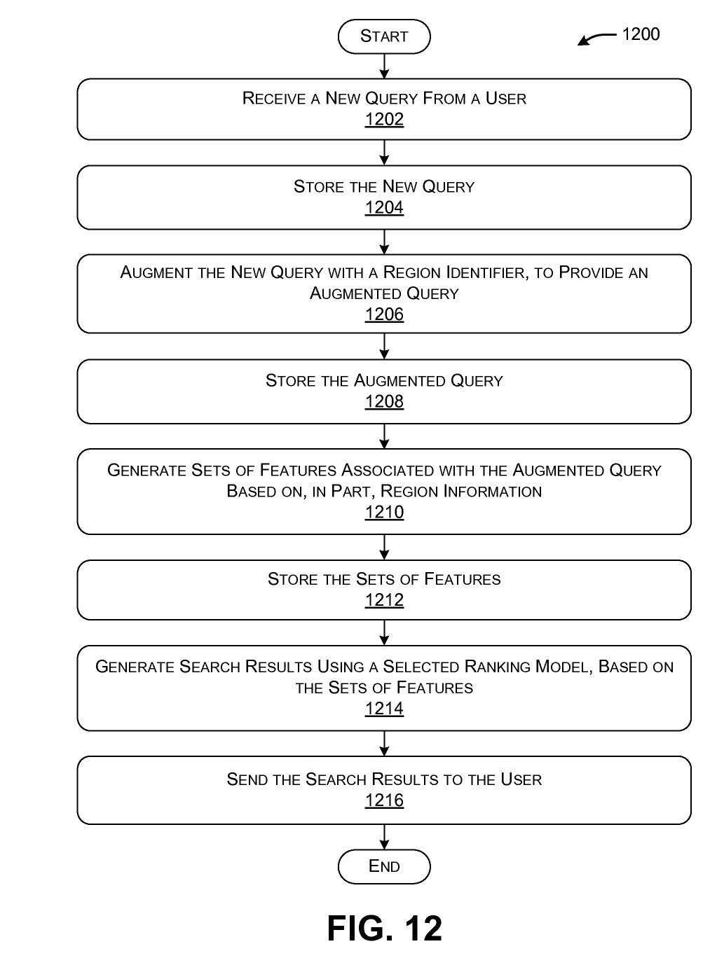

FIG. 12 shows a procedure 1200 that sets forth one illustrative manner of operation of the query processing environment 600 of FIG. 6. In block 1202, the query processing environment 600 receives a new query from a user. In block 1204, the query processing environment 600 stores the query. In block 1206, the query processing environment 600 augments the query with a region identifier, to provide an augmented query. In block 1208, the query processing environment 600 stores the augmented query.

In block 1210, the query processing environment 600 generates a set of features for each pairing of a query and a particular candidate result item. These features may include the general-purpose features and the location-related features described above. In block 1214, the query processing environment 600 generates search results using a selected ranking model, based on the sets of features generated in block 1210. In block 1216, the query processing environment 600 sends the search results to the user.

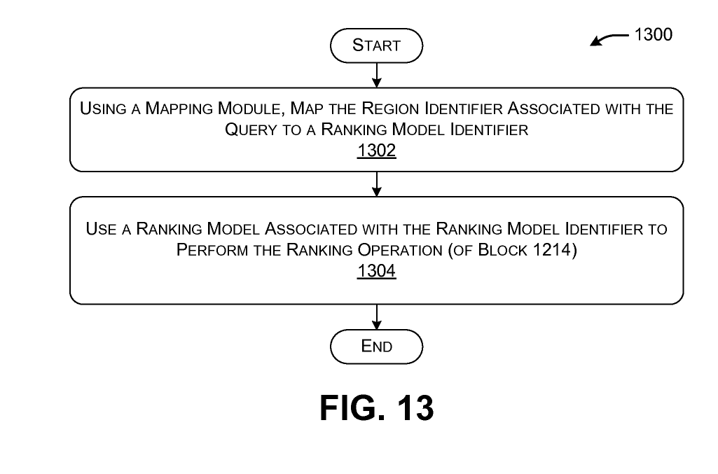

FIG. 13 shows a procedure 1300 that sets forth one manner of selecting and applying a particular ranking model, within the context of the procedure of FIG. 12. In block 1302, the query processing environment 600 maps a region identifier to a particular ranking model identifier, by using a mapping model. In block 1304, the query processing environment 600 uses a ranking model associated with the ranking model identifier to perform a ranking operation (e.g., the ranking operation in block 1214 of FIG. 12).

C. Representative Computing Functionality

FIG. 14 sets forth illustrative computing functionality 1400 that can be used to implement any aspect of the functions described above. For example, the computing functionality 1400 can be used to implement any aspect of the training environments (100, 300) of FIGS. 1 and 3, the query processing environment of FIG. 6, etc. In one case, the computing functionality 1400 may correspond to any type of computing device that includes one or more processing devices. In all cases, the computing functionality 1400 represents one or more physical and tangible processing mechanisms.

The computing functionality 1400 can include volatile and non-volatile memory, such as RAM 1402 and ROM 1404, as well as one or more processing devices 1406 (e.g., one or more CPUs, and/or one or more GPUs, etc.). The computing functionality 1400 also optionally includes various media devices 1408, such as a hard disk module, an optical disk module, and so forth. The computing functionality 1400 can perform various operations identified above when the processing device(s) 1406 executes instructions that are maintained by memory (e.g., RAM 1402, ROM 1404, or elsewhere).

More generally, instructions and other information can be stored on any computer readable storage medium 1410, including, but not limited to, static memory storage devices, magnetic storage devices, optical storage devices, and so on. The term computer readable storage medium also encompasses plural storage devices. In all cases, the computer readable storage medium 1410 represents some form of physical and tangible entity.

The computing functionality 1400 also includes an input/output module 1412 for receiving various inputs (via input modules 1414), and for providing various outputs (via output modules). One particular output mechanism may include a presentation module 1416 and an associated graphical user interface (GUI) 1418. The computing functionality 1400 can also include one or more network interfaces 1420 for exchanging data with other devices via one or more communication conduits 1422. One or more communication buses 1424 communicatively couple the above-described components together.

The communication conduit(s) 1422 can be implemented in any manner, e.g., by a local area network, a wide area network (e.g., the Internet), etc., or any combination thereof. The communication conduit(s) 1422 can include any combination of hardwired links, wireless links, routers, gateway functionality, name servers, etc., governed by any protocol or combination of protocols.

Alternatively, or in addition, any of the functions described in Sections A and B can be performed, at least in part, by one or more hardware logic components. For example, without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc.

In closing, the functionality described herein can employ various mechanisms to ensure the privacy of user data maintained by the functionality. For example, the functionality can allow a user to expressly opt in to (and then expressly opt out of) the provisions of the functionality. The functionality can also provide suitable security mechanisms to ensure the privacy of the user data (such as data-sanitizing mechanisms, encryption mechanisms, password-protection mechanisms, etc.).

Further, the description may have described various concepts in the context of illustrative challenges or problems. This manner of explanation does not constitute an admission that others have appreciated and/or articulated the challenges or problems in the manner specified herein.

Finally, although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method, implemented by computing functionality, for providing at least one ranking model, comprising:
receiving original search log data that provides information regarding searches conducted by a plurality of users;
storing the original search log data in a data store;
augmenting the original search log data with region identifiers, to provide augmented search log data, each region identifier identifying a region associated with a query in the original search log data;
storing the augmented original search data in a data store;
generating features associated with the augmented search log data based on, at least in part, region information, the region information encoding characteristics about regions which are associated with the queries in the augmented search log data;
storing the features;
training at least one ranking model based on at least the features; and
storing said at least one ranking model,
wherein said receiving, storing the original search log data, augmenting, storing the augmented search log data, generating, storing the features, training, and storing said at least one ranking model are performed by the computing functionality.

2. The method of claim 1, wherein one feature encodes a population density of a region from which a query originated.

3. The method of claim 1, wherein one feature encodes an average traveling distance for a region from which a query originated, the average traveling distance corresponding to an average distance that users are willing to travel to reach target entities.

4. The method of claim 1, wherein one feature encodes a standard deviation of traveling distances for a region from which the query originated, the traveling distances corresponding to distances that users are willing to travel to reach target entities.

5. The method of claim 1, wherein one feature encodes a self-sufficiency value for a region from which a query originated, the self-sufficiency value indicating an extent to which users within the region have selected target entities outside the region in response to queries issued by the users.

6. The method of claim 1, wherein one feature encodes a fractional value for a region from which a query originated, the fractional value indicating a fraction of query volume that the region receives, with respect to a total volume associated with a more encompassing region.

7. The method of claim 1, wherein the features for a query include at least:
a first feature that encodes a population density of a region from which the query originated;
a second feature that encodes an average traveling distance for the region, the average traveling distance corresponding to an average distance that users are willing to travel to reach target entities;
a third feature that encodes a standard deviation of the traveling distances for the region;
a fourth feature that encodes a self-sufficiency value for the region, the self-sufficiency value indicating an extent to which users within the region have selected target entities outside the region in response to queries issued by the users; and
a fifth feature that encodes a fractional value for the region, the fractional value indicating a fraction of query volume that the region receives, with respect to a total volume associated with a more encompassing region.

8. The method of claim 1, wherein said training of said at least one ranking module comprises training a single ranking model that implicitly takes into account characteristics of different regions.

9. The method of claim 1, further comprising:
partitioning the augmented search log data into a plurality of datasets, each dataset corresponding to a respective map area,
wherein said generating is performed for each dataset to produce a plurality of collections of features, and
wherein said training is performed on the plurality of collections of features to produce a plurality of respective ranking models, each ranking model being associated with a respective map area.

10. The method of claim 9, further comprising:
testing a performance of each ranking model for each map area with respect to a dataset associated with each region, to provide a plurality of performance results for the respective regions; and
determining a mapping model based on the plurality of performance results, the mapping model mapping each region to a ranking model to be used to process queries in a query-time phase of operation.

11. The method of claim 1, further comprising deploying said at least one ranking model in a query processing system for processing new queries.

12. The method of claim 11, wherein a query-time phase of operation of the query processing system comprises:
receiving a new query from a user;
augmenting the new query with a region identifier, the region identifier identifying a region from which the new query originated;
generating sets of features for the augmented query based on, at least in part, region information that encodes characteristics about the region from which the new query originated;
a ranking module for generating search results for the augmented query based on the sets of features, using a ranking model; and
sending the search results to the user.

13. A query processing system, comprising:
an interface for receiving a query from a user;
a query augmentation module for augmenting the query with a region identifier, the region identifier identifying a region from which the query originated;
a feature generation module for generating sets of features for the augmented query based on, at least in part, region information that encodes characteristics about the region from which the query originated; and
a ranking module for generating search results for the augmented query based on the sets of features, using a ranking model,
the interface configured to send the search results to the user.

14. The query processing system of claim 13, wherein each set of features for the query includes at least one of:
a first feature that encodes a population density of the region from which the query originated;
a second feature that encodes an average traveling distance for the region, the average traveling distance corresponding to an average distance that users are willing to travel to reach target entities;
a third feature that encodes a standard deviation of the traveling distances for the region;
a fourth feature that encodes a self-sufficiency value for the region, the self-sufficiency value indicating an extent to which users within the region have selected target entities outside the region in response to queries issued by the users; and
a fifth feature that encodes a fractional value for the region, the fractional value indicating a fraction of query volume that the region receives, with respect to a total volume associated with a more encompassing region.

15. The query processing system of claim 14, wherein each set of features includes two or more of said first through fifth features.

16. The query processing system of claim 13, further comprising a data store which provides a plurality of ranking models for respective map areas, and wherein the ranking model that is used by the ranking module is selected from the plurality of ranking models in the data store.

17. The query processing system of claim 13, further comprising:
a model selecting module for mapping, based on a mapping model, the query identifier associated with the query to a ranking model identifier, and
wherein the ranking model that is used by the ranking module is associated with the ranking model identifier.

18. A computer readable storage medium for storing computer readable instructions, the computer readable instructions providing a training system when executed by one or more processing devices, the computer readable instructions comprising:
logic for receiving augmented search log data that provides information regarding searches conducted by a plurality of users, together with region identifiers, each region identifier identifying a region associated with a query in the augmented search log data;
logic for forming region information based on the augmented search log data, the region information encoding characteristics about regions which are associated with queries in the augmented search log data, the region information comprising two or more of:
population information that encodes population densities of respective regions from which queries in the augmented search log data originated;
average traveling distance information that encodes average traveling distances for the respective regions, each average traveling distance corresponding to an average distance for a particular region that users are willing to travel to reach target entities;
standard deviation information that encodes standard deviations for the respective regions, each standard deviation indicating a standard deviation of the traveling distances for a particular region;
self-sufficiency information that encodes self-sufficiency values for the respective regions, each self-sufficiency value indicating an extent to which users within a particular region have selected target entities outside the region in response to queries issued by the users; and
fractional volume information that encodes fractional values for the respective regions, each fractional value indicating a fraction of query volume that a particular region receives, with respect to a total volume associated with a more encompassing region; and
storing the region information in a data store.

19. The computer readable storage medium of claim 18, wherein the region information includes all of the population information, average traveling distance information, standard deviation information, self-sufficiency information, and fractional volume information.

20. The computer readable storage medium of claim 18, further comprising:
logic for generating features associated with the augmented search log data based on, at least in part, the region information;
logic for storing the features;
logic for training at least one ranking model based on, at least in part, the features; and
logic for storing said at least one ranking model.
